(19) United States
(12) Patent Application Publication
(10) Pub. No.: US 2006/0066254 A1
(43) Pub. Date: Mar. 30, 2006

(54) Organic EL pixel circuit

(76) Inventors: Akifumi Sasaki, Ogaki-shi (JP); Shoichiro Matsumoto, Ogaki-shi (JP)

Correspondence Address: CANTOR COLBURN, LLP, 55 GRIFFIN ROAD SOUTH, BLOOMFIELD, CT, 06002, US

(21) Appl. No.: 11/236,195

(22) Filed: Sep. 27, 2005

(30) Foreign Application Priority Data
Sep. 30, 2004 (JP) 2004-289366

(51) Int. Cl. G09G 3/10

(52) U.S. Cl. 315/169.3

(57) ABSTRACT

In a state where a selection TFT is off, a control TFT is turned off and a reset control TFT and a short-circuit TFT are turned on. This results in the selection TFT side of a capacitor to be set to PVDD so that the short-circuit TFT turns on and a drive TFT is connected to a diode. Then, a voltage lower then PVDD by a threshold voltage of the drive TFT is set to the gate of the drive TFT. Next, the reset control TFT and the short-circuit TFT are turned off so that the control TFT is turned on. The gate voltage of the drive TFT is shifted by the voltage of a video signal on a data line DL so that the drive TFT turns on and a driving current is supplied to an organic EL device. As a result, the driving current can be controlled, independently of the threshold voltage of the drive TFT, in accordance with the video signal.

### CROSS-REFERENCE TO RELATED APPLICATIONS

The entire disclosure of Japanese Patent Application Nos. 2004-289366, 2003-342469 and 2004-289368 including specification, claims, drawings, and abstract is incorporated herein by reference.

### BACKGROUND OF THE INVENTION

1. Field of the Invention

The present invention relates to an organic EL pixel circuit for controlling drive current to be supplied to an organic EL device in accordance with data signals.

2. Description of the Related Art

An electroluminescence (EL) display apparatus using an EL device as a light emitting device at each pixel is seen as the display apparatus to replace liquid crystal displays (LCD) and CRTs due to advantages, such as thinness, low power consumption, and so forth.

In particular, a high definition display is possible on an active-matrix EL display apparatus by providing a switching device, such as a thin-film transistor (TFT) for controlling individual EL devices, and controlling the EL device at each pixel.

The active-matrix EL display apparatus includes multiple gate lines on a substrate extending in the row (horizontal) direction and multiple data lines and power supply lines extending in a column (vertical) direction, with an organic EL device, selection TFT, drive TFT, and storage capacitor at each pixel. Selecting a gate line turns on a selection TFT so that a data voltage (voltage video signal) on a data line is charged to a storage capacitor, the drive TFT is turned on by the voltage stored in the storage capacitor, and power from the power supply line is supplied to the organic EL device.

However, the problem with this type of pixel circuit is that if there are variations in the threshold voltage of the drive TFT in the pixel circuits arranged in a matrix, the luminance may vary and the display quality may decrease. At the same time, it is difficult to achieve identical characteristics for the TFTs forming the pixel circuits of the entire display panel and difficult to prevent variations in the on-off threshold.

Thus, it is desirable to prevent any influence with respect to the display from variations in threshold in the drive TFTs.

Various techniques have been proposed for circuits to prevent the influence on fluctuations in the TFT threshold. (For example, WO98/48403A1.)

However, such techniques require circuits to compensate for threshold fluctuations. Therefore, the problem is that the use of such a circuit results in an increased number of components in the pixel circuit and a small aperture ratio. Furthermore, another problem is that the addition of a circuit for compensation requires the peripheral circuitry for driving the pixel circuits to be modified.

### SUMMARY OF THE INVENTION

The pixel circuit of the present invention includes a drive transistor for supplying a driving current in accordance with voltage at a control terminal from a power supply to an organic EL device, a control transistor for turning on and off the driving current, a short-circuit transistor for controlling whether or not the drive transistor functions as a diode (connecting gate and drain of the drive transistor), a selection transistor for controlling whether or not a data signal from a data line is to be supplied to the control terminal of the drive transistor, a capacitor that is provided between the selection transistor and the control terminal of the drive transistor, and a reset control transistor for turning on and off a connection between the selection transistor side of the capacitor and a power supply of a certain voltage.

According to the present invention, while the selection transistor is off, the control transistor is turned off and the short-circuit transistor and the reset control transistor are turned on, and a voltage corresponding to a threshold voltage of the drive transistor is set to the control terminal of said drive transistor and can be stored in the capacitor. Therefore, even if there are variations in the threshold voltage among the drive transistors of various pixels, compensation is achieved, and a current corresponding to a video signal can be supplied to the organic EL device.

In particular, the voltage on the selection transistor side of the capacitor is set to a certain voltage (power supply voltage, for example) by the reset control transistor. Thus, when the influence of the previous write data is eliminated and the short-circuit transistor is turned on, the voltage corresponding to the threshold voltage of the drive transistor can be reliably held at the capacitor. Furthermore, when setting the threshold voltage, it is not necessary to vary the voltage of the data line and the operation of the horizontal driver is simplified. Moreover, if the selection transistor is in an off period, the data line can be reset at any timing, and the threshold voltage can be reliably set by extending the reset time.

Furthermore, connecting the control terminal of the control transistor to a reset control line, which is separate from that to which the control terminals of the short-circuit transistor and the reset control transistor are connected, can reliably prevent the short-circuit transistor and the control transistor from turning on simultaneously.

Moreover, the control transistor has a polarity opposite to that of the short-circuit transistor and the reset control transistor, and the control terminal of the control transistor is connected to the same reset control line as the control terminals of the short-circuit transistor and the reset control transistor so that the number of lines can be reduced.

Furthermore, the control transistor is turned on while the selection transistor is in an on period, then the selection transistor is turned off. When the control transistor is turned on, current begins to flow to the organic EL device, and as a result, the voltage at the terminal on the organic EL device side of the drive transistor decreases so that the control terminal voltage of the drive transistor tends to decrease. However, in the present invention, the selection transistor is on at this time. The voltage on the data line side of the capacitor tends not to change so that fluctuations in the control terminal voltage of the drive transistor can be suppressed.

Moreover, the drive transistor is a p-channel transistor and the control transistor is an n-channel transistor. A diode is formed between the drive transistor and the control transistor so that the drive transistor and the control transistor can be formed using the same semiconductor layer, making efficient layouts possible.

### BRIEF DESCRIPTION OF THE DRAWINGS

FIG. 1 is a circuit diagram showing a configuration of an embodiment.

FIG. 2 is a signal waveform diagram illustrating an operation of the embodiment.

FIG. 3 is a circuit diagram showing a configuration of another embodiment.

FIG. 4 is a circuit diagram showing a configuration of another embodiment.

FIG. 5 is a circuit diagram showing a configuration of another embodiment.

FIG. 6 is a signal waveform diagram illustrating an operation of another embodiment.

FIG. 7 is a circuit diagram showing a configuration of another embodiment.

FIG. 8 shows a configuration of a circuit generating reset signals RST1 and RST2.

FIG. 9 is a signal waveform diagram illustrating an operation of the circuit shown in FIG. 8.

### DETAILED DESCRIPTION OF THE PREFERRED EMBODIMENTS

Embodiments of the present invention are described hereinafter with reference to the attached drawings.

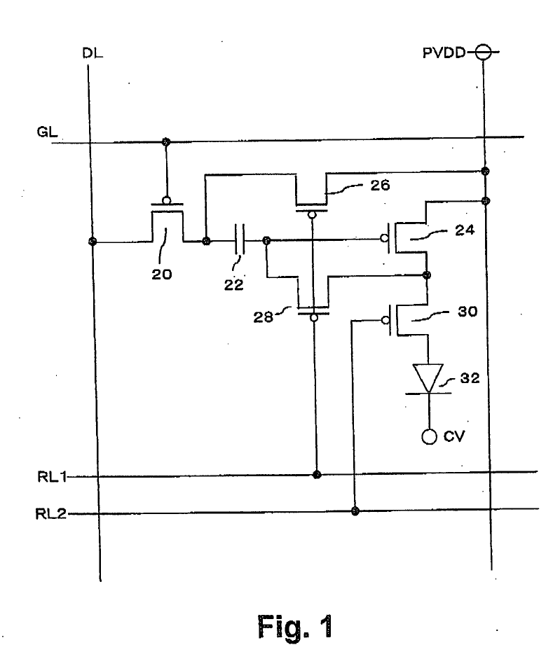

FIG. 1 shows a configuration of a pixel circuit for one pixel relating to the embodiment. The drain of a p-channel selection TFT 20 is connected to a data line DL extending in the vertical direction. The gate of the selection TFT 20 is connected to a gate line GL extending in the horizontal direction and the source is connected to one end of a capacitor 22. The other end of the capacitor 22 is connected to the gate of a p-channel drive TFT 24. Furthermore, the drain of a p-channel reset control TFT 26 is connected to the source of the selection TFT 20 and to the capacitor 22. The source of the reset control TFT 26 is connected to a power line PVDD extending in the vertical direction. Moreover, the gate of the drive TFT 24 is connected to the source of a p-channel short-circuit TFT 28 and the drain of the short-circuit TFT 2B is connected to the drain of the drive TFT 24. The gates of the reset control TFT 26 and the short-circuit 28 are connected to a reset line RL1.

Furthermore, the source of the drive TFT 24 is connected to the power line PVDD and the drain is connected to the source of a p-channel control TFT 30. The drain of the control TFT 30 is connected to the anode of an organic EL device 32 and the gate is connected to a reset line RL2 extending in the horizontal direction. The cathode of the organic EL device 32 is connected to a cathode power CV. Ordinarily, the cathode of the organic EL device 32 is in common with all pixels and the cathode is connected to the cathode power CV having a predetermined voltage.

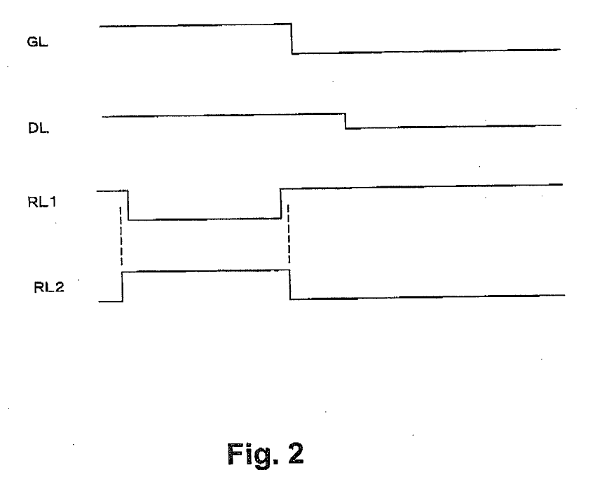

The operation of this pixel circuit will be described next with reference to FIG. 2. The gate line CL becomes an L level only during the selection period of one horizontal scan period in which the pixel of the horizontal line is selected. Prior to this selection period, the reset line RL2 becomes an H level and after a delay of a predetermined short period A, the reset line RL1 becomes an L level. As a result, with the selection TFT 20 in the off state, the control TPT 30 turns off, and the reset control TFT 26 and the short-circuit TFT 28 turn on.

As a result, in a state in which the side of the capacitor 22 opposite to where is connected the gate of the drive TFT 24 is maintained at the voltage of PVDD, the gate and drain of the drive TFT 24 are short circuited by the short-circuit TFT 28 so that the drive TFT 24 functions as a diode. The gate voltage of the drive TFT 24 is lower than the PVDD by a threshold voltage Vt. The voltage of this threshold voltage Vt is held at the capacitor 22. After charging to the capacitor 22 in this manner completes, the reset line RL1 becomes an H level, and after a predetermined short period the reset line RL2 becomes an L level, the reset control TFT 26 and the short-circuit TFT 28 turn off, after which the control TFT 30 turns on.

Next, the selection period of the horizontal line is entered and the gate line GL becomes an L level. As a result, the selection TFT 20 turns on. In this state, the horizontal driver sequentially supplies the video signal, which is supplied from the video line, for each pixel to each data line. Therefore, the video signal for the corresponding pixel is set to the data line DL. The data line DL then holds the voltage of the video signal until the gate line GL becomes an H level. For this reason, it is desirable to hold the voltage, such as by connecting a capacitor to the data line DL.

After the gate line GL is returned to the H level, the data line is initially returned to a certain voltage (for example, PVDD). This thereby obviates the problem of setting the data line DL for the next video signal.

When the data line DL is set to the voltage of the video signal, the gate voltage of the drive TFT 24, which is the other end of the capacitor 22, is shifted by the voltage of the video signal, and the current corresponding to the gate voltage flows to the organic EL device 32 via the drive TFT 24 and the control TFT 30. Even after the gate line GL returns to the H level and the selection TFT 20 turns off, the gate voltage of the drive TFT 24 at the time is maintained.

In this manner, in this embodiment, a voltage lower than PVDD by the threshold voltage Vt of the drive TFT 24 is first set to the gate of the drive TFT 24 and is held by the capacitor 22. Therefore, even if there are variations in the threshold voltage Vt among the drive TFTs 24 of the various pixels, to compensate for this a current corresponding to the video signal can be supplied to the organic EL device 32.

In particular, the voltage at the selection TFT 20 side of the capacitor 22 is set to a certain voltage (PVDD in this example) by the reset control TFT 26. Thus, when the influence of the write data at the previous frame is eliminated and the short-circuit TFT 28 is turned on, the voltage corresponding to the threshold voltage Vt of the drive TFT 24 can be reliably held at the capacitor 22. Furthermore, when setting the threshold voltage, it is not necessary to vary the voltage of the data line DL and the operation of the horizontal driver is simplified. Moreover, if the corresponding gate line GL is in an H level period, the data line can be reset at any timing, and the threshold voltage can be reliably set by extending the reset time.

Furthermore, in this embodiment, the reset control TFT 26 and the short-circuit TFT 28 are driven simultaneously. However, the off period of the control TFT 30 is extended beyond the on period of the reset control TFT 26 and the short-circuit TFT 28, and the reset control TFT 26 and the short-circuit 28 turn on only in the off period of the control TFT 30. As a result, when the control TFT 30 turns on, this prevents the drive TFT 24 from functioning as a diode so as to reliably prevent undesirable current from flowing to the organic EL device 32.

Furthermore, in this pixel circuit, p-channel TFTs are used for all the transistors, the fabrication of which is easy. However, except for the drive TFT 24, the transistors may be changed to n-channel TFTs without any problems. It should be noted that it will be necessary to reverse the polarity of the control signal. Furthermore, for the drive TFT 24 also, if means are provided to keep its source voltage fixed, an n-channel TFT may be adopted.

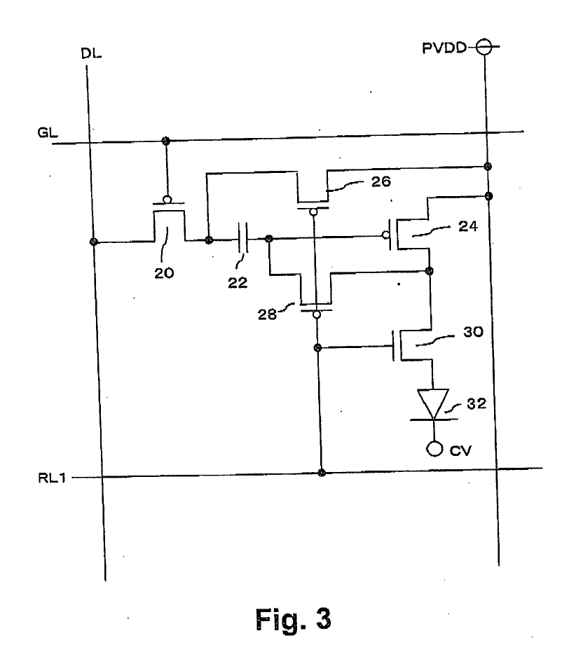

FIG. 3 shows another example configuration. In this example, an n-channel TFT having a polarity opposite to that of the reset control TFT 26 and the short-circuit TFT 28 is utilized for the control TFT 30. The gate of the n-channel control TFT 30 is connected to the reset line RL1 together with the gates of the reset control TFT 26 and the short-circuit TFT 28. As a result, by setting the reset line RL1 to an H level, the control TFT 30 turns on and the reset control TFT 26 and the short-circuit TFT 28 turn off, and by setting the reset line RL1 to an L level, the control TFT 30 turns off and the reset control TFT 26 and the short-circuit TFT 28 turn on.

In this configuration, one reset line RL1 is utilized to control the on-off operations of the control TFT 30, the reset control TFT 26, and the short-circuit TFT 28. Therefore, an advantage is that this configuration can be implemented with only one reset line. Furthermore, although the off operation of the control TFT 30 and the on operation of the short-circuit TFT are performed simultaneously, it is possible for both to turn on. However, the n-channel control TFT 30 operates faster and switches off before the p-channel short-circuit TFT 28 so as to prevent both from turning on simultaneously.

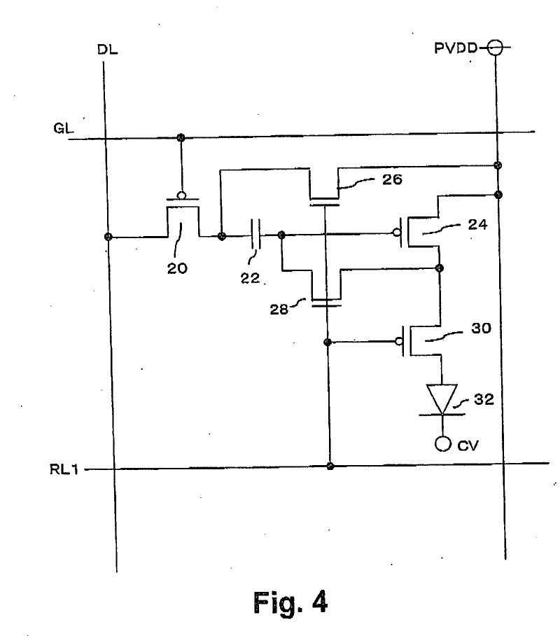

FIG. 4 shows another example configuration. In this example, the reset control TFT 26 and the short-circuit TFT 28 are n-channel TFTs and a p-channel TFT having an opposite polarity is utilized for the control TFT 30. The gate of the p-channel control TFT 30 is connected to the reset line RL1 together with the gates of the reset control TFT 26 and the short-circuit TFT 28. As a result, by setting the reset line RL1 to an H level, the reset control TFT 26 and the short-circuit TFT 28 turn on and the control TFT 30 turns off, and by setting the reset line RL1 to an L level, the reset control TFT 26 and the short-circuit 28 turn off and the control TFT 30 turns on.

In this configuration, which is similar to the configuration in FIG. 3, one reset line RL1 is utilized to control the on-off operations of the reset control TFT 26, the short-circuit TFT 28, and the control TFT 30. Thus, an advantage is that only one reset line is used.

### Another Example Configuration

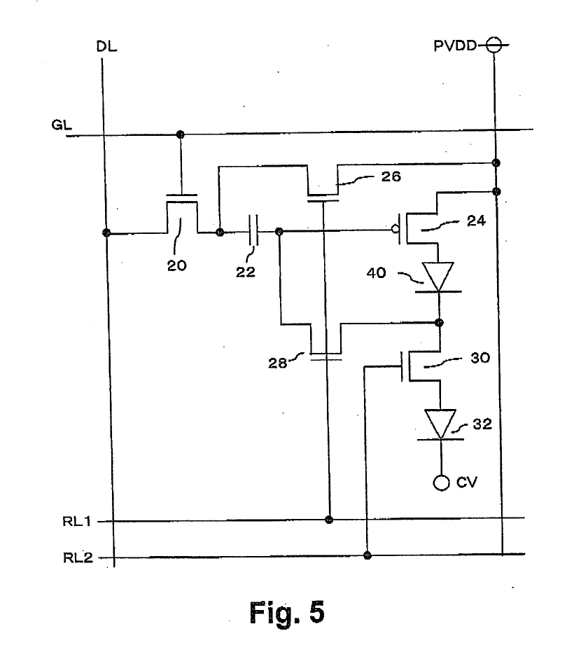

FIG. 5 shows yet another example configuration. In this example, except for the drive TFT 24, n-channel TFTs are utilized for the selection TFT 20, the reset control TFT 26, the short-circuit TFT 28, and the control TFT 30.

The drive TFT 24 and the control TFT 30 are configured using one continuous semiconductor layer. The drain of the drive TFT 24 is doped with p-type impurities while the drain of the control TFT 30 is doped with n-type impurities. A diode 40 is created from a pn junction in the continuous semiconductor layer. As shown in the figure, disposing the diode 40 on the drive TFT 24 side from the connection with the short-circuit TFT 28 eliminates the current from the short-circuit TFT 28 to the control TFT 30 from being obstructed so that resetting of the gate voltage of the drive TFT 24 is performed without problem. If the drive TFT 24 and the control TFT 30 are formed using different semiconductor layers and their connections utilize a metal layer, the diode 40 can be omitted. However, this case requires two contacts with the metal layer, which becomes a disadvantage in the layout process.

The source of the control TFT 30 is connected to the anode of the organic EL device 32 and the gate is connected to the reset line RL2 extending in the horizontal direction. The cathode of the organic EL device 32 is connected to the cathode power Cv. Ordinarily, in this case, the cathode of the organic EL device 32 is in common with all pixels and the cathode is connected to the cathode power CV having a predetermined voltage.

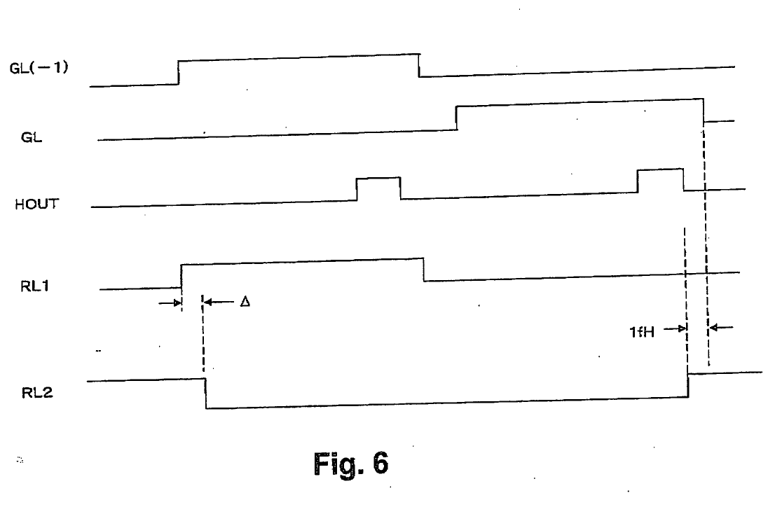

The operation of this pixel circuit will be described next with reference to FIG. 6. The gate line GL becomes an H level only during the selection period of 1H (horizontal period) in which the pixel of the horizontal line (row) is selected. In the figure, the gate line GL (−1) is for one horizontal line above the current horizontal line and has an H level for the previous 1H. When GL (−1) becomes an H level, the reset line RL1 simultaneously becomes an H level. Due to the H level of the reset line RL1, with the selection TFT 20 off and the control TFT 30 on, the reset control TFT 26 and the short-circuit TFT 28 turn on and a predetermined current flows to the organic EL device 32. As a result, with the selection TFT 20 side of the capacitor 22 at the state of power voltage PVDD, the drain and source of the drive TFT 24 are short circuited and charge is removed from the gate of the drive TFT 24 and reset.

After a delay of a predetermined short period A, the reset line RL2 becomes an L level and the control TFT 30 turns off. On the other hand, since the reset control TFT 26 and the short-circuit TFT 28 are on, with the side of the capacitor opposite where the gate of the drive-TFT 24 is connected maintained at the voltage of PVDD, the gate and drain of the drive TFT 24 are short circuited by the short-circuit TFT 28 so that the drive TFT 24 functions as a diode. The gate voltage of the drive TFT 24 has a voltage lower than PVDD by threshold voltage Vt and this threshold voltage Vt is held at the capacitor 22.

In this manner, in the horizontal scan period of the previous horizontal scan period, the threshold voltage Vt of the drive TFT 24 is stored in the capacitor 22. Next, the reset line RL1 becomes an L level and the reset control TFT 26 and the short-circuit TFT 28 turn off. The reset line RL2 is maintained at the L level and the control TFT 30 remains off.

Next, the selection period of the horizontal line is entered and the gate line GL becomes an H level. As a result, the selection TFT 20 turns on. In this state, the horizontal driver sequentially supplies the video signal for each pixel to each data line DL. Therefore, the video signal for the corresponding pixel is set to the data line DL. The data line DL then holds the voltage of the video signal until the gate line GL becomes an L level. For this reason, it is desirable to hold the voltage, such as by connecting a capacitor to the data line DL.

When the data line DL is set to the voltage of the video signal, the gate voltage of the drive TFT 24, which is the other end of the capacitor 22, is shifted by the voltage (data voltage) of the video signal. Then, when the reset line RL2 becomes an H level, the control TFT 30 turns on and current flows to the drive TFT 24 corresponding to the gate voltage and then to the organic EL device 32 via the control TFT 30. Even after the gate line GL returns to the L level and the selection TFT 20 turns off, the gate voltage of the drive TFT 24 at the time is maintained and current flows to the organic EL device 32 corresponding to the voltage of the video signal so that light is emitted.

After the gate line GL is returned to the L level, the data line DL is initially returned to a certain voltage (for example, PVDD). This thereby obviates the problem of setting the data line DL for the next video signal.

In this manner, in this embodiment, a voltage lower than PVDD by the amount of the threshold voltage Vt of the drive TFT 24 is initially set to the gate of the drive TFT 24 and then held by the capacitor 22. Therefore, even if there are variations in the threshold voltage Vt among the drive TFTs 24 of the various pixels, to compensate for this a current corresponding to the video signal can be supplied to the organic EL device 32.

In particular, the voltage at the selection TPT 20 side of the capacitor 22 is set to a certain voltage (PVDD in this example) by the reset control TFT 26. Thus, when the influence of the write data at the previous frame is eliminated and the short-circuit TFT 28 is turned on, the voltage corresponding to the threshold voltage Vt of the drive TFT 24 can be reliably held at the capacitor 22. Furthermore, when setting the threshold voltage Vt, it is not necessary to vary the voltage of the data line DL and the operation of the horizontal driver is simplified. Moreover, if the corresponding gate line GL is in an L level period, the gate voltage of the drive transistor can be reset at any timing and the threshold voltage can be reliably set by lengthening the reset time.

Furthermore, in a state where the control TFT 30 is on, the reset control TFT 26 and the short-circuit TFT 28 are simultaneously turned on. Thus, the gate voltage of the drive TFT 24 is reliably reset.

In this embodiment, in a state where the gate line GL is at an H level and the selection TFT 20 is on, the reset line RL2 is set to an H level and the control TFT 30 is turned on. When the control TFT 30 turns on, current begins to flow to the organic EL device 32, the drain voltage of the drive TFT 24 decreases, and as a result, the gate voltage also tends to decrease. In this embodiment, when the control TFT 30 turns on, the selection TFT 20 turns on and one end of the capacitor 22 is connected to the data line DL. Therefore, with the control TFT 30 turning on, even if the drain voltage of the drive TFT 24 fluctuates, the voltage of the above-mentioned end of the capacitor 22 tends not to fluctuate so that the gate voltage also tends not fluctuate. The voltage conforming to the input video data can be held to achieve the illumination of the organic EL device 32 in accordance with the data voltage.

Furthermore, when the control TFT 30 is a p-channel type, there is a tendency for current to leak. When the short-circuit TFT 28 between the gate and drain of the drive TFT 24 is turned on and the gate voltage of the drive TFT 24 is set to PVDD-Vt, the gate voltage tends to decrease. By having the control TFT 30 as an n-channel type, the leakage current is decreased and the gate voltage of the drive TFT 24 can be set accurately.

Furthermore, in this embodiment, PVDD is less than 5V and the black level voltage of the data voltage to be set to the data line DL set at about 2 V higher than PVDD. As a result, the gate of the drive TFT 24 during black level is set sufficiently high with respect to PVDD, which is the voltage of the source, so as to prevent current from flowing and to achieve black level.

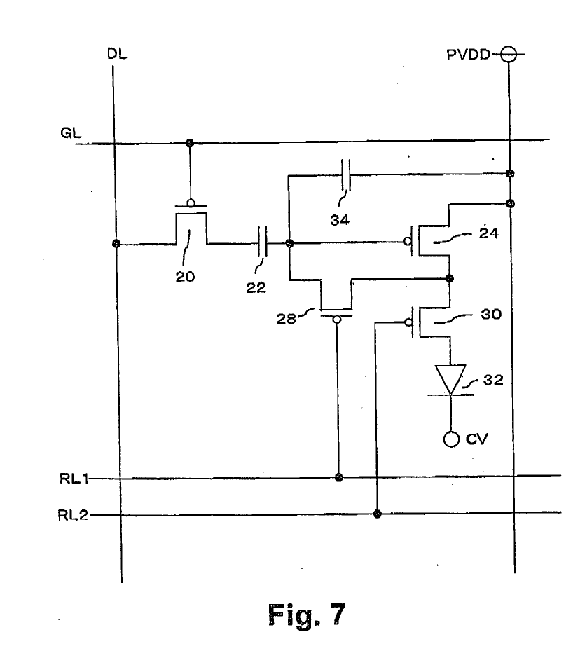

FIG. 7 shows an example configuration of another pixel circuit. In this circuit, the reset control TFT 26 is omitted and instead is provided a capacitor 34, of which one end is connected to the power line PVDD and the other end is connected to the gate of the drive TFT 24. Furthermore, the selection FT 20, the short-circuit TFT 28, and the control TFT 30 all are formed from p-channel TFTs. This pixel circuit is identical to that disclosed in Patent Document 1 and operates in the same manner.

In this embodiment, the on operation of the short-circuit TFT 28 and the on operation of the control TFT 30 are timed as shown in FIG. 2 so as to be slightly shifted (by A). Since p-channel TFTs are utilized in this embodiment, the polarity of the signal supplied to each line becomes reversed.

In this embodiment, when the selection TFT 20 is on, the control TFT 30 is turned on. As a result, similar to the above-mentioned case, together with the on operation of the control TFT 30, the gate voltage of the drive TFT 24 can be prevented from decreasing.

### Configuration of Timing Generator Circuit

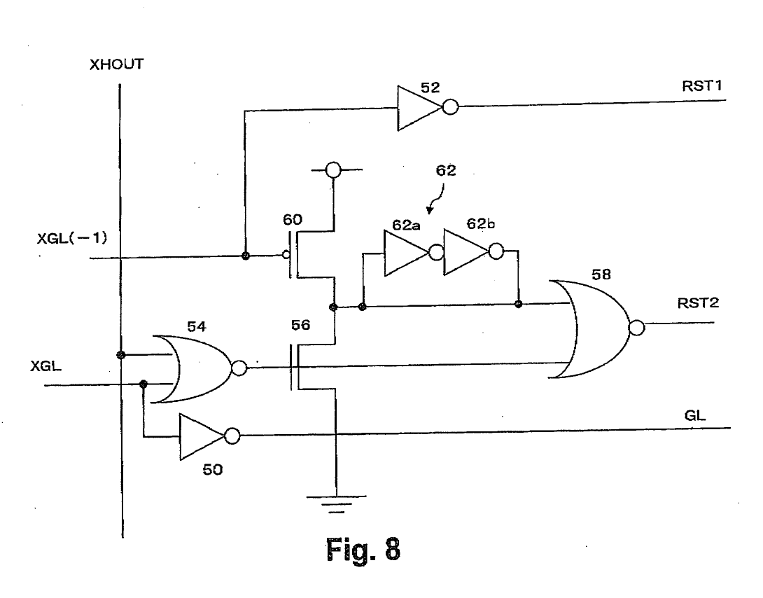

FIG. 8 shows a generator circuit for signals RST1 and RST2 to be supplied to the above-mentioned reset lines RL1 and RS2.

As input signals, XGL (−1), which is an inverted signal of the gate signal of one horizontal line above, XGL, which is an inverted signal of the gate signal of the current horizontal line, and XHOUT, which is an inverted signal of the output signal of the final stage of the horizontal direction driver, are utilized.

XGL is inverted by an inverter 50 and GL is output. Furthermore, XGL (−1) is inverted by an inverter 52 and output as the reset signal RST1.

XGL and XHOUT are input by a NOR gate 54. The output of the NOR gate 54 is supplied to the gate of an n-channel TFT 56 and is also input by a NOR gate 58.

The TFT 56 has its source connected to ground and its drain connected to the drain of a p-channel TFT 60, while the source of the TFT 60 is connected to a power supply. Furthermore, XGL (−1) is supplied to the gate of the TFT 60.

The connection of the TFT 60 and the TFT 56 is input by the NOR gate 58 and to this input line is connected a latch circuit 62, which is formed from serially connected inverters 62a, 62b. Namely, the connection of the TFT 60 and the TFT 56 in the input line of the NOR gate 58 is input by the inverter 62a and the output of the inverter 62b is returned. Therefore, if the level at the connection of the TFT 60 and the TFT 56 changes, the change is input by the latch circuit 62 and the input to the NOR gate 58 changes.

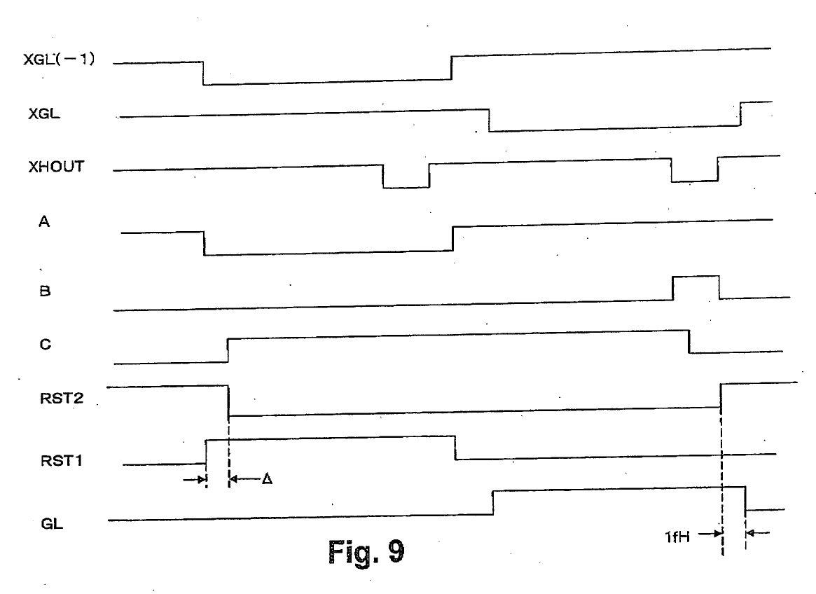

The operation in this circuit will be described with reference to FIG. 9. XGL (−1) and XGL are L level signals only for the selection period of one horizontal line and their L levels are shifted by only 1H. XHOUT is a signal that becomes an L level once per 1H and becomes an L level prior to the end of the period where the gate signal of each line becomes an L level and becomes an H level slightly prior to when the gate signal becomes an H level.

Due to these signals, a signal A that is input by the gate of the TFT 60 is the same as XGL (−1). A signal B, which is the output signal of the NOR gate 54, becomes an H level only when both XGL and XHOUT are L levels.

Furthermore, a signal C of the input line of the NOR gate 58 rises from the L level of XGL (−1) and falls from the H level of the NOR gate 54. Here, the difference in performance between the TFTs 60, 56 and when the latch circuit 62 requires time in writing for the latch circuit 62r a delay is created in accordance with the difference in performance. Namely, although the connecting point of the TFT 60 and the TFT 56 attempts to rise in accordance with the fall of XGL (−1), the rise is delayed by the period A until the output of the latch circuit 62 becomes an H level. On the other hand, also when the output of the NOR gate 54 becomes an H level, the signal B becomes an L level after a delay of Δ.

Furthermore, the reset signal RST2 is the output of the NOR gate 58 and is an H level only when both inputs to the NOR gate 58 are at L levels. Therefore, the reset signal RST2 becomes an L level at the rise of the signal C and thereafter becomes an H level at the fall of the signal B.

In this manner, the fall of the reset signal RST2 is slightly delayed compared to the rise of the reset signal RST1. This delay time is determined by the difference between the performance of the TFTs 60, 56 and the performance of the inverters 62a, 62b forming the latch circuit 62. For example, it is preferable to set the performance of the inverters 62a, 62b forming the latch circuit 62 so as to be around twice the performance of the TFTs 60, 56. As a result, for example, a delay of 400 ns can be obtained. On the other hand, if this degree of delay is obtained with a capacitor, a substantial area will be required. Thus, this circuit enables an effective signal delay to be designed.

On the other hand, the rise of the reset signal RST2 is synchronized with the rise of the XHOUT signal. The fall of the gate line GL is early by a predetermined short time 1fH (1fH is a minimum period, such as around 200 ns). Therefore, this circuit enables both the selection TFT 20 and the control TFT 30 to turn on only for a predetermined time.

In this manner, according to this circuit, a predetermined delay time can be obtained from the difference in performance between the driver, which is formed from the two serially connected TFTs 56, 60, and the latch circuit 62. Therefore, the required area can be reduced when compared to an ordinary circuit in which a capacitor is added and its charging time is utilized.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A pixel circuit to be used in an organic electroluminescence (EL) display apparatus, the pixel circuit comprising:
a drive transistor for supplying a driving current in accordance with voltage at a control terminal from a power supply to an organic EL device;
a control transistor for turning on and off said driving current;
a short-circuit transistor for controlling whether or not said drive transistor functions as a diode;
a selection transistor for controlling whether or not a data signal from a data line is to be supplied to the control terminal of said drive transistor;
a capacitor that is disposed between the selection transistor and the control terminal of said drive transistor; and
a reset control transistor for turning on and off a connection between said selection transistor side of the capacitor and a power supply of a certain voltage.

2. A pixel circuit according to claim 1, wherein:
said control transistor is turned off and said short-circuit transistor and the reset control transistor are turned on while said selection transistor is off, a voltage corresponding to a threshold voltage of said drive transistor is set to the control terminal of said drive transistor, then the selection transistor is turned on, the voltage at the control terminal of said drive transistor is shifted by a data voltage supplied to a data line, and in accordance with this shifted voltage a driving current for the organic EL device is supplied to the drive transistor.

3. A pixel circuit according to claim 1, wherein:
the power supply that is connected to another end of said reset control transistor and the power supply supplying driving current to said drive transistor are the same power supply line.

4. A pixel circuit according to claim 1, wherein:
said short-circuit transistor and the reset control transistor have identical polarities, the respective control terminals thereof are both connected to a first control line.

5. A pixel circuit according to claim 4, wherein:
the control terminal of said control transistor is connected to a second control line, which is provided separately from the first control line whereto said short-circuit transistor and the reset control transistor are connected, and after said control transistor is turned off, said short-circuit transistor and the reset control transistor are turned on, and after said short-circuit transistor and the reset control transistor are turned off, said control transistor is turned on.

6. A pixel circuit according to claim 5, wherein:
after said control transistor turns on, said selection transistor is turned on, the voltage at the control terminal of said drive transistor is shifted by a data voltage supplied to a data line, and in accordance with this shifted voltage a driving current for the organic EL device is supplied to said drive transistor.

7. A pixel circuit according to claim 5, wherein:
after said selection transistor is turned on and the voltage of the control terminal of said drive transistor is shifted by the data voltage supplied to the data line, said control transistor is turned on while said selection transistor is on, then said selection transistor is turned off.

8. A pixel circuit according to claim 4, wherein:
the control terminal of said control transistor is connected to a second control line, which is provided separately from the first control line whereto said short-circuit transistor and the reset control transistor are connected, and after said short-circuit transistor and the reset control transistor are turned on, said control transistor is turned off, and after said short-circuit transistor and the reset control transistor are turned off, said control transistor is turned on.

9. A pixel circuit according to claim 8, wherein:
after said control transistor turns on, said selection transistor is turned on, the voltage at the control terminal of said drive transistor is shifted by a data voltage supplied to a data line, and in accordance with this shifted voltage a driving current for the organic EL device is supplied to said drive transistor.

10. A pixel circuit according to claim 8, wherein:
after said selection transistor is turned on and the voltage of the control terminal of said drive transistor is shifted by the data voltage supplied to the data line, said control transistor is turned on while said selection transistor is on, then said selection transistor is turned off.

11. A pixel circuit according to claim 4, wherein:
said control transistor has a polarity opposite to that of said short-circuit transistor and the reset control transistor and the control terminal of said control transistor is connected to the same first control line as said short-circuit transistor and the reset control transistor.

12. A pixel circuit according to claim 1, wherein:
said drive transistor is a p-channel transistor and said control transistor is an n-channel transistor.

13. A pixel circuit according to claim 12, wherein:
a diode through which current flows from the drive transistor side to the control transistor side said drive transistor is disposed between said drive transistor and said control transistor.

14. A pixel circuit according to claim 13, wherein:
a drain of said drive transistor and a drain of said control transistor are formed from a continuous semiconductor layer and said diode is formed from a PN junction at a connection of these drains.

15. A pixel circuit according to claim 1, wherein:
after said short-circuit transistor and the reset control transistor are turned on in a state where said selection transistor is off and said control transistor is on, the control transistor is turned off and the control terminal voltage of the drive transistor is set to a predetermined voltage, then with the control transistor off, the short-circuit transistor and the reset control transistor are turned off, the selection transistor is turned on, a data voltage is applied to the control terminal of the drive transistor, then the control transistor is turned on while the selection transistor is on, then the selection transistor is turned off.

16. A pixel circuit according to claim 15, further comprising:
a first control line to which is connected the control terminal of said selection transistor for controlling on-off operations of the selection transistor;
a second control line to which are connected the control terminals of said short-circuit transistor and the reset control transistor for controlling on-off operations of these transistors; and
a third control line for controlling on-off operations of said control transistor.

17. A pixel circuit according to claim 16, wherein:
the third control line is activated in a state where said first control line is active, then said first control line is deactivated so that the control transistor is turned on while the selection transistor is on, then the selection transistor is turned off.

18. A pixel circuit to be used in an organic EL display apparatus, the pixel circuit comprising:
a drive transistor for supplying a driving current in accordance with voltage at a control terminal from a power supply to an organic EL device;
a control transistor for turning on and off said driving current;
a short-circuit transistor for controlling whether or not said drive transistor functions as a diode;
a selection transistor for controlling whether or not a data signal from a data line is to be supplied to the control terminal of said drive transistor;
a first capacitor that is disposed between the selection transistor and the control terminal of said drive transistor; and
a second capacitor, of which one end is connected to the control terminal of said drive transistor and another end is connected to said power supply;
after the short-circuit transistor is turned on in a state where the selection transistor is off and the control transistor is on, the control transistor is turned off and the control terminal voltage of the drive transistor is set to a predetermined voltage, then with the control transistor off, the short-circuit transistor is turned off and the selection transistor is turned on, a data voltage is applied to the control terminal of the drive transistor, then the control transistor is turned on while the selection transistor is on, then the selection transistor is turned off.

19. A pixel circuit according to claim 18, further comprising:
a first control line to which is connected the control terminal of said selection transistor for controlling on-off operations of the selection transistor;
a second control line to which is connected the control terminal of said short-circuit transistor for controlling on-off operations of the short-circuit transistor; and
a third control line for controlling on-off operations of said control transistor.

20. A pixel circuit according to claim 19, wherein:
the third control line is activated in a state where said first control line is active, then said first control line is deactivated so that the control transistor is turned on while the selection transistor is on, then the selection transistor is turned off.

21. A pixel circuit to be used in an organic EL display apparatus, the pixel circuit comprising:
a drive transistor for supplying a driving current in accordance with voltage at a control terminal from a power supply to an organic EL device;
a control transistor for turning on and off said driving current;
a short-circuit transistor for controlling whether or not said drive transistor functions as a diode;
a selection transistor for controlling whether or not a data signal from a data line is to be supplied to the control terminal of said drive transistor; and
a capacitor that is disposed between the selection transistor and the control terminal of said drive transistor;
the selection transistor and the short-circuit transistor are turned on in a state where the data line is set to a predetermined voltage, one end of said capacitor is furnished with the same voltage as the data line and the control terminal charge of said drive transistor is discharged;
next, the control transistor is turned off and after the control terminal voltage of the drive transistor is set to a predetermined voltage, the short-circuit transistor is turned off;
next, with the control transistor off, the data voltage is set to the data line, the data voltage is held in the capacitor and the data signal is applied to the control terminal of the drive transistor, then the control transistor is turned on while the selection transistor is on, then the selection transistor is turned off.

22. A pixel circuit according to claim 21, further comprising:
a first control line to which is connected the control terminal of said selection transistor for controlling on-off operations of the selection transistor;
a second control line to which is connected the control terminal of said short-circuit transistor for controlling the on-off operations of the short-circuit transistor; and
a third control line for controlling on-off operations of said control transistor.

23. A pixel circuit according to claim 22, wherein:
the third control line is activated in a state where said first control line is active, then said first control line is deactivated so that the control transistor is turned on while the selection transistor is on, then the selection transistor is turned off.
